(19) United States
(12) Patent Application Publication
(10) Pub. No.: US 2025/0238177 A1
(43) Pub. Date: Jul. 24, 2025

(54) COMPUTER PROGRAM PRODUCT, PRINTING SUPPORT APPARATUS, ADVERTISEMENT PRINTING SYSTEM, AND PRINTING SUPPORT METHOD

(71) Applicant: Konica Minolta, Inc., Tokyo (JP)

(72) Inventor: Shinya HASHIMOTO, Nishinomiya-shi (JP)

(21) Appl. No.: 19/021,956

(22) Filed: Jan. 15, 2025

(30) Foreign Application Priority Data
Jan. 23, 2024 (JP) 2024-008299

(51) Int. Cl. G06F 3/12; B41J 3/407; B41J 3/44; B41J 11/66; G06Q 30/0251

(52) U.S. Cl. CPC G06F 3/1253; B41J 3/4075; B41J 3/44; B41J 11/66; G06F 3/1204; G06Q 30/0255; G06Q 30/0265

(57) ABSTRACT

A non-transitory computer-readable storage medium storing a program executable by a computer, the program causing the computer to execute: print product information acquisition processing of acquiring print product information on a print product that is to be packed with an item to be shipped; processing of acquiring, based on the print product information, a piece of document data of the print product that is to be packed with the item to be shipped from among pieces of document data of print products, the pieces of document data of print products having been prepared in advance; print job generation processing of generating a print job to print the piece of document data; processing of providing the print job to a printer and causing the printer to output the print product.

### CROSS-REFERENCE STATEMENT

The present application is based on, and claims priority from, Japanese Patent Application Number 2024-008299, filed Jan. 23, 2024, the disclosure of which is hereby incorporated by reference herein in its entirety

### BACKGROUND OF THE INVENTION

### Technical Field

The disclosure relates to a computer program product, a printing support apparatus, an advertisement printing system, and a printing support method for printing an advertisement to be packed with a product to be shipped.

### Description of Related Art

E-commerce for purchasing an item (a piece of merchandise) via the Internet has become popular. In order to encourage the purchaser to purchase next time, a sales business operator (brand) often sends the piece of merchandise in a package with a paper medium for advertisement, such as a leaflet or a booklet.

At a distribution site, a leaflet is packed together in a parcel in order to meet a request of a brand. It takes time to pick a leaflet in accordance with a different piece of merchandise purchased by each purchaser. Furthermore, in a case where a plurality of brands or pieces of merchandise are handled, the number of leaflets will become large, and carrying out a check to prevent wrong leaflets from being included in a package will be time consuming.

In order to reduce work involved in leaflet picking, there is a system in which a plurality of types of print products are collected for each package using a collating machine. Furthermore, there is a system in which a delivery slip and a label or the like may be printed by a plurality of printers at the time of packaging, and sheets may be conveyed by a conveyor from respective outputs to be collected. However, these systems require a large investment.

As an invention for printing an advertisement to be packed with a piece of merchandise, there is a shipment management system described in Japanese Unexamined Patent Publication Number 2023-086189 (hereinafter “Patent Literature 1”). This shipment management system includes the following: a core system that acquires information on a piece of merchandise ordered by a customer and information on the customer; and a print support system that supports printing of an advertisement that is to be packed with the piece of merchandise when the piece of merchandise is shipped to the customer. The print support system includes a document creating unit that creates document data of the advertisement to be packed with the piece of merchandise, based on the information on the piece of merchandise and the information on the customer that are acquired by the core system. The print support system further includes an instruction unit that instructs a controller of a printer to start printing so that printing of the advertisement based on the document data ends in accordance with the timing of shipping the piece of merchandise.

According to the shipment management system described in Patent Literature 1, since an advertisement to be packed together with a piece of merchandise is printed, work involved in leaflet picking may be reduced. However, in the shipment management system described in Patent Literature 1, a document creation unit is used to create a document by laying out from the beginning the advertisement that is to be packed with the piece of merchandise. When this is performed at a distribution site, it will be necessary to confirm whether or not the created document data is in accordance with the intention of the sales business operator (brand). However, this will be difficult to realize, and the system does not match the actual situation at a current distribution site. In addition, a computer and software will be necessary to create an advertisement document. Further, it will also be necessary to define an algorithm for estimating a document creation time for synchronizing with the shipping timing.

### SUMMARY OF THE INVENTION

An object of the disclosure is to provide a computer program product, a printing support apparatus, an advertisement printing system, and a printing support method that are capable of reducing man-hours related to an operation of picking a print product to be packed with a piece of merchandise in a form that is suited to an actual condition of a distribution site.

To achieve at least one of the abovementioned objects, according to an aspect of the disclosure, a non-transitory computer-readable storage medium reflecting one aspect of the disclosure stores a program that is executable by a computer. The program causes the computer to execute the following: print product information acquisition processing of acquiring print product information on a print product that is to be packed with an item to be shipped; processing of acquiring, based on the print product information, a piece of document data of the print product that is to be packed with the item to be shipped from among pieces of document data of print products, the pieces of document data of print products having been prepared in advance; print job generation processing of generating a print job to print the piece of document data; and processing of providing the print job to a printer and causing the printer to output the print product.

Another aspect of the disclosure provides a printing support apparatus including a hardware processor. The hardware processor is configured to perform the following: acquire print product information on a print product that is to be packed with an item to be shipped; acquire, based on the print product information, a piece of document data of the print product that is to be packed with the item to be shipped from among pieces of document data of print products, the pieces of document data of print products having been prepared in advance; generate a print job of printing the piece of document data; and provide the print job to a printer and cause the printer to output the print product.

Another aspect of the disclosure provides an advertisement printing system including a printing support apparatus and a printer. The printing support apparatus includes a hardware processor. The hardware processor is configured to perform the following: acquire print product information on a print product that is to be packed with an item to be shipped; acquire, based on the print product information, a piece of document data of the print product that is to be packed with the item to be shipped from among pieces of document data of print products, the pieces of document data of print products having been prepared in advance; generate a print job for printing the piece of document data; and provide the print job to a printer and cause the printer to output the print product.

Another aspect of the disclosure provides a printing support method of a printing support apparatus. The printing support method includes the following: acquiring print product information on a print product that is to be packed with an item to be shipped; acquiring, based on the print product information, a piece of document data of the print product that is to be packed with the item to be shipped from among pieces of document data of print products, the pieces of document data of print products having been prepared in advance; generating a print job for printing the piece of document data; and providing the print job to a printer and causing the printer to output the print product.

### BRIEF DESCRIPTION OF THE DRAWINGS

Advantages and features provided by one or more embodiments of the disclosure will become more fully understood from the detailed description given hereinbelow and the appended drawings which are given by way of illustration only, and thus are not intended as a definition of the limits of the disclosure.

FIG. 1 is a configuration diagram of an advertisement printing system according to a first embodiment.

FIG. 2 is a diagram illustrating a configuration of shipping package information according to the first embodiment.

FIG. 3 is a flowchart of printing support processing according to the first embodiment

FIG. 4 is a diagram for explaining a packaging work according to the first embodiment.

FIG. 5 is a diagram for explaining a packaging work according to the first embodiment.

FIG. 6 is a configuration diagram of an advertisement printing system according to a second embodiment.

### DETAILED DESCRIPTION

Hereinafter, one or more embodiments of the disclosure will be described with reference to the drawings. However, the scope of the invention is not limited to the disclosed embodiments.

### Overview of Advertisement Printing System

Hereinafter, an advertisement printing system according to an embodiment of the disclosure will be described. The advertisement printing system includes a printing support apparatus that generates a print job for printing an advertisement that is to be packed with a piece of merchandise (an item) to be shipped. The advertisement printing system includes a printer that receives the print job and prints the advertisement.

The printing support apparatus acquires document data of a leaflet, a booklet, or the like related to a piece of merchandise to be shipped, generates a print job, and sends the print job to the printer. The printer prints a leaflet, a booklet, or the like and ejects it to a single ejection section (ejection tray). A print product may include a delivery slip or a letter of appreciation or both the delivery slip and the letter of appreciation.

A worker who packages the piece of merchandise may obtain print products such as the leaflet, delivery slip, or letter of appreciation from the single ejection section and pack the print products as they are with the piece of merchandise. Picking a leaflet according to a piece of merchandise or sales business operator is not necessary, and efficient and mistake-free packaging work may be performed.

In addition, even in a case where, when picking a plurality of leaflets, an order in which the plurality of leaflets are to be packed is designated by a sales business operator (brand), since the order may be designated at the time of printing, the packaging work may be performed without paying particular attention.

### Configuration of Advertisement Printing System

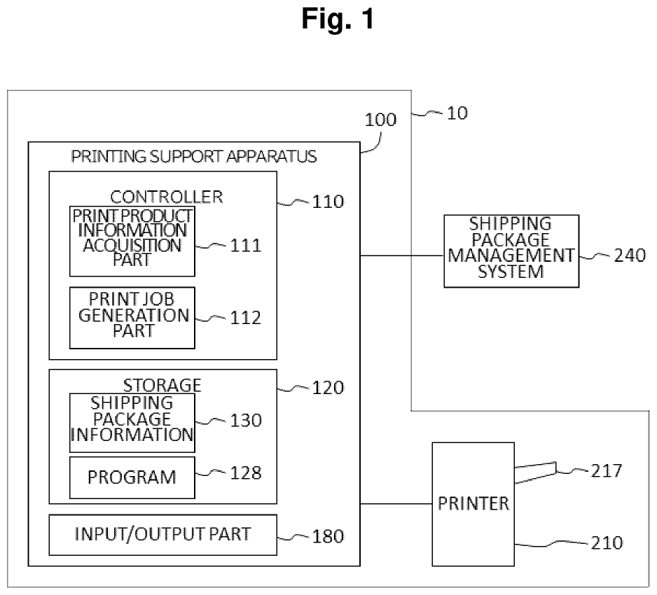

FIG. 1 is a configuration diagram of an advertisement printing system 10 according to a first embodiment. The advertisement printing system 10 includes a printing support apparatus 100 and a printer 210. The shipping package management system 240 holds, for each shipping package to be sent, information such as a piece of merchandise and a leaflet to be packed, a shipping destination (destination), and a shipping date and time.

### Configuration of Printing Support Apparatus

The printing support apparatus 100 is a computer and includes a controller 110, a storage 120, and an input/output part 180. A user interface device (not illustrated) such as a display, a keyboard, or a mouse is connected to the input/output part 180. The input/output part 180 includes a communication device and may transmit and receive data to and from other devices such as the shipping package management system 240 and the printer 210.

### Printing Support Apparatus: Storage

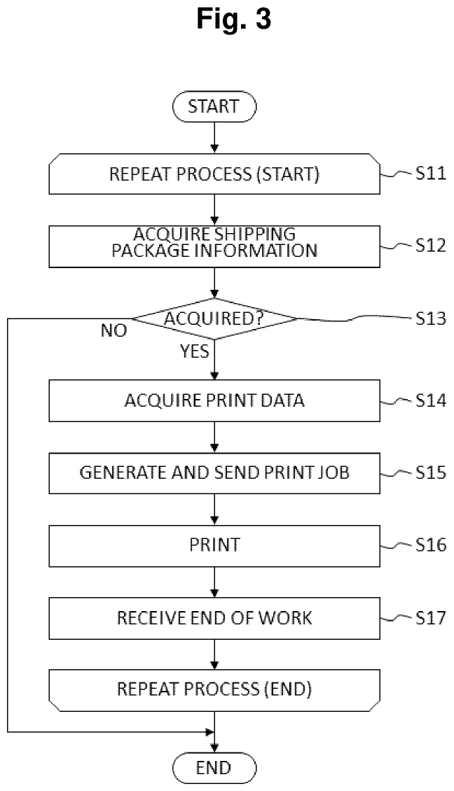

The storage 120 includes a storage device such as a read only memory (ROM), a random access memory (RAM), or a solid state drive (SSD). The storage 120 stores therein shipping package information 130 and a program 128. The program 128 includes a description of processing (refer to FIG. 3) of each functional part included in the controller 110 that is described later.

### Storage: Shipping Package Information

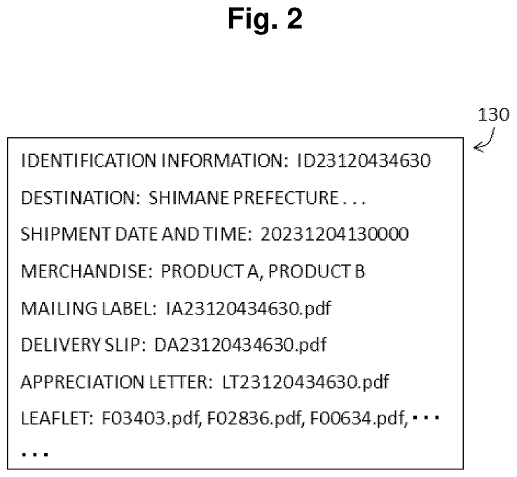

FIG. 2 is a diagram illustrating a configuration of a shipping package information 130 according to the first embodiment. Each shipping package information 130 is information on a shipping package (an item to be sent). The shipping package information 130 may include information such as identification information, a destination, a shipment date and time, information on merchandise, information on a mailing label, information on a delivery slip, information on a letter of appreciation, and/or information on a leaflet.

The identification information is identification information of the shipping package. The destination is a destination of the shipping package. The shipping date and time is a scheduled date and time when the shipping package is to be shipped (sent).

The information on merchandise includes identification information or a name of a piece of merchandise that is to be shipped and may also include the number of the piece of merchandise. The number of the piece of merchandise may not be limited to one. There may be a plurality of the same piece of merchandise or a plurality of different pieces of merchandise.

The information on a mailing label is identification information of a file that includes print data (document data) of a mailing label that includes a destination. The information on a delivery slip is identification information of a file that includes print data of a delivery slip indicating the piece of merchandise to be shipped. The information on a letter of appreciation is identification information of a file that includes print data of a letter of appreciation in which a thank-you message for an order is written. Contents of the letter of appreciation may be changed depending on the number of times a customer has made an order. The letter of appreciation may include a name of the customer or merchandise information.

The information on a leaflet includes identification information of a file that includes print data of an advertisement for a piece of merchandise or an advertisement of a sales business operator. Even when there is one piece of merchandise to be shipped, the number of leaflets is not limited to one, and the information on a leaflet may include identification information of a plurality of files. A size of the leaflet (a document size) may not be limited to one, and there may be a plurality of sizes. A sheet (a medium) on which the leaflet is printed may not be limited to one. Examples of a sheet include plain paper, coated paper, and the like.

### Printing Support Apparatus: Controller

The controller 110 will be described with reference to FIG. 1. The controller 110 is configured to include a central processing unit (CPU). The controller 110 includes a print product information acquisition part 111 and a print job generation part 112.

The print product information acquisition part 111 acquires the shipping package information 130 (print product information) from the shipping package management system 240. The print product information acquisition part 111 further acquires print data (document data) of a mailing label, a delivery slip, a letter of appreciation, and a leaflet. In other words, the print product information acquisition part 111 acquires document data and print product information including data related to one or more items to be shipped and to a print product that is to be packed with the one or more items.

The print job generation part 112 generates a print job based on print data of the mailing label, the delivery slip, the letter of appreciation, and the leaflet. Next, the print job generation part 112 transmits the generated print job to the printer 210. In the print job, the mailing label is instructed (set) to be printed on a sticker sheet. In addition, in the print job, print products are instructed to be ejected to one ejection section 217 (ejection tray) of the printer 210. Note that the print job generated by the print job generation part 112 may include an instruction to print print products of differing document sizes.

### Printing Support Processing

FIG. 3 is a flowchart of printing support processing according to the first embodiment. Processing of the printing support apparatus 100 and the printer 210 will be described with reference to FIG. 3.

In step S11, the print product information acquisition part 111 starts a process of repeating steps S12 to S17.

In step S12, the print product information acquisition part 111 accesses the shipping package management system 240 to acquire the shipping package information 130.

In step S13, if the print product information acquisition part 111 has succeeded in acquiring the shipping package information 130 in step S12 (step S13→YES), the print product information acquisition part 111 proceeds to step S14. If the print product information acquisition part 111 fails to acquire the shipping package information 130 (step S13→NO), the print product information acquisition part 111 ends the printing support processing.

In step S14, the print product information acquisition part 111 acquires print data based on identification information of files included in the information on a mailing label, information on a delivery slip, information on a letter of appreciation, and information on a leaflet of the shipping package information 130 (see FIG. 2).

In step S15, the print job generation part 112 generates a print job based on the print data acquired in step S14. Next, the print job generation part 112 transmits the generated print job to the printer 210.

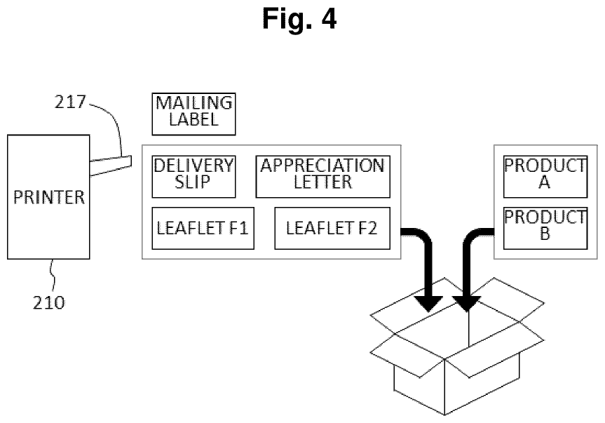

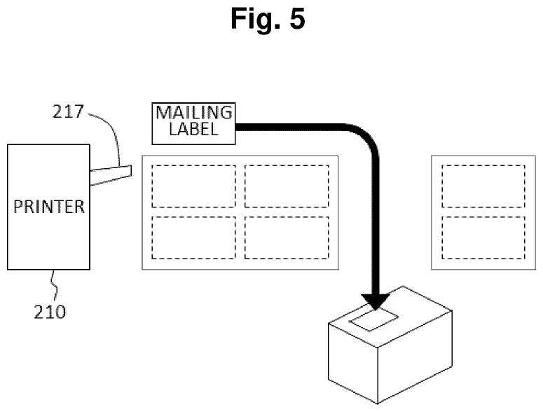

In Step S16, the printer 210 prints a mailing label, a delivery slip, a letter of appreciation, and a leaflet and ejects them to the ejection section 217. A worker packs the delivery slip, the letter of appreciation, and the leaflet in a box together with a piece of merchandise, and attaches a mailing label onto the box for shipment (see FIGS. 4 and 5 to be described later). Next, the worker reports to the printing support apparatus 100 that the packaging and shipping work has been completed. For example, the worker presses a key indicating an end of work on the keyboard connected to the printing support apparatus 100 to report an end of the work.

In step S17, the print product information acquisition part 111 receives the report of the end of the work, and the process returns to step S12.

### Packaging Work

FIGS. 4 and 5 are diagrams for explaining a packaging work (see step S16 illustrated in FIG. 3) according to the first embodiment. As shown in FIG. 4, out of the print products that have been ejected to the ejection section 217, the worker takes the delivery slip, letter of appreciation, and leaflet and packs them in a box together with the piece of merchandise. Next, as illustrated in FIG. 5, the worker affixes the mailing label to the box and ships the box. For example, the worker moves the box to a shipping belt conveyor to ship the box. Next, the worker reports an end of the work to the printing support apparatus 100.

### Feature of Advertisement Printing System

According to the advertisement printing system 10, print products, such as the delivery slip, letter of appreciation, or leaflet, to be packed in the shipping package may be collectively printed and ejected to the ejection section 217. For this reason, the worker does not need to pick a leaflet according to a piece of merchandise or a sales business operator. Therefore, efficiency of the work may be improved, and a mistake of packing a wrong leaflet may be reduced.

Furthermore, the mailing label may be printed on a sticker sheet and may be printed together with another print product such as the delivery slip, letter of appreciation, or leaflet and ejected to the ejection section 217. Therefore, it may be possible to avoid attaching a wrong mailing label, and mis-shipment may be prevented.

### Modification Example: Mailing Label

In the above-described embodiment, a printing (ejection) order of print products, such as the mailing label, the delivery slip, the letter of appreciation, or the leaflet, is not defined. Since the mailing label is not packed unlike the delivery slip, the letter of appreciation, and the leaflet, the mailing label may be ejected first or last. In other words, the print job generating part 112 may generate a print job that includes a setting (an instruction) to print the mailing label first or last.

In the embodiment described above, the mailing label is ejected to the same ejection section 217 as the delivery slip, the letter of appreciation, and the leaflet. The mailing label may be ejected to an ejection section that is different from the ejection section 217. Since the mailing label is attached on a box, the mailing label may be ejected to an ejection section that is different from the ejection section 217 so as not to be packed by mistake.

### Modification Example: Ejection Section

In the above-described embodiment, an ejection destination of the delivery slip, the letter of appreciation, and the leaflet is set to the ejection section 217 in the print job. Alternatively, the ejection destination may not be set by the print job but may be set to the ejection section 217 by a setting of the printer 210.

### Second Embodiment

In the above-described first embodiment, the mailing label, delivery slip, letter of appreciation, and leaflet may be printed on a sheet (a medium) stored in a sheet feed section (sheet feed tray) included in the printer 210. The printer 210 may include a cutter to create a leaflet of a non-standard size. Further, by using a cutter, a full-bleed (rimless) leaflet may be produced.

### Second Embodiment: Configuration of Advertisement Printing System

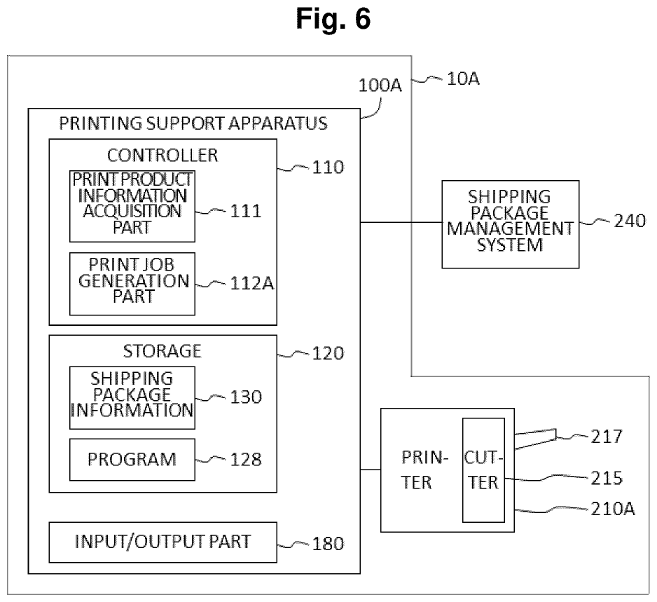

FIG. 6 is a configuration diagram of an advertisement printing system 10A according to a second embodiment. The printing support apparatus 100A of the advertisement printing system 10A is different from that of the first embodiment in that the print job generation part 112A is different. The print job generation part 112A generates a print job that includes an instruction to print on a sheet and cutting information instructing how to cut the printed sheet. The printer 210A of the advertisement printing system 10A includes a cutter 215 and may cut the printed sheet in accordance with the cutting information.

The print job generation part 112A may generate a print job that includes an instruction to print a plurality of leaflets on one sheet and cut the printed sheet to separate the leaflets. For example, the print job generation part 112A generates a print job that includes an instruction to print a leaflet of a non-standard size on a sheet whose size is greater than the aforementioned non-standard size and to cut the printed sheet into the aforementioned non-standard size.

The printing job generation part 112A may generate a print job that includes an instruction to print two leaflets of A4 size on one sheet of A3 size and to cut the printed sheet into two sheets of A4 size. Note that in the case of printing a plurality of print products on one sheet, information on an arrangement of individual print products in the sheet is called imposition information. The print job generation part 112A may generate a print job including imposition information and cutting information and send the print job to the printer 210A. The printer 210A may perform printing according to the imposition information and cut the printed sheet according to the cutting information.

### Second Embodiment: Feature of Advertisement Printing System

By using the advertisement printing system 10A, it may be possible to create a leaflet of a non-standard size or to create a full bleed leaflet and pack such a leaflet with a piece of merchandise. Similarly to the first embodiment, the efficiency of the packaging work may be improved, and making a mistake of packing a wrong leaflet may be reduced.

### Modification Example: Priority Specification

Providing the printer 210A with the cutter 215 makes it possible to print the same print product using different sheets. For example, in addition to printing two leaflets of A4 size on two sheets of A4 size, the two leaflets may be created by printing on a sheet of A3 size and then cutting the sheet. A printing method (a sheet) may be selected in accordance with a priority specified by the worker. Priorities may include speed, cost, and a type of paper (medium, printing medium).

### Priority Specification: Speed

When speed is prioritized, the print job generation part 112A generates a print job including an instruction to print a plurality of print products, such as a delivery slip, letter of appreciation, or leaflet, on a large-sized sheet using a minimum number of sheets (the number of sheets may be one) and to cut the large-sized sheet. For example, when three leaflets of A5 size are to be printed, the print job generation part 112A generates a print job including an instruction to print on one sheet of A3 size and then to cut the sheet. In this way, the number of one or more sheets to be printed may be minimized, and the time required for printing and ejection may be minimized.

### Priority Specification: Cost

When priority is given to cost, the print job generation part 112A obtains a combination of a sheet and imposition that may provide the lowest sheet cost and printing cost. Next, the print job generation part 112A generates a print job including an instruction to print and cut the sheet with this combination. For example, consider a scenario where costs of A3-, A4-, and A5-sized sheets are 100 JPY, 50 JPY, and 25 JPY respectively (JPY stands for Japanese Yen). Further, consider that one side printing costs 20 JPY. In a case of creating three, one-sided leaflets of A5 size, when three leaflets are imposed and printed on one A3-sized sheet, the sheet cost and printing cost amounts to 120 JPY. When two leaflets are imposed and printed on one A4-sized sheet and one leaflet is printed on one A5-sized sheet, the sheet cost and printing cost amounts to 115 JPY. In this case, the print job generation part 112A generates a print job including an instruction to print two leaflets on an A4-sized sheet and cut said sheet and to print one leaflet on an A5-sized sheet.

### Priority Specification: Sheet

When there is a sheet to be preferentially used and a use of said sheet is prioritized, the print job generation part 112A generates a print job that prioritizes the use of said sheet for printing. When the A5-sized sheet is prioritized, the print job generation part 112A generates a print job of printing on three A5-sized sheets. The sheet cost and printing cost amounts to 135 JPY, which is higher than when cost is prioritized.

### OTHER MODIFICATION EXAMPLES

While certain embodiments of the disclosure have been described, these embodiments have been presented by way of example only and are not intended to limit the technical scope of the disclosure. For example, the shipping package information 130 (see FIG. 2) includes identification information of files that include print data of a delivery slip, a letter of appreciation, and a leaflet. Alternatively, the shipping package information 130 may include the print data itself.

In the above-described embodiment, the printing support apparatus 100 and the printer 210, 210A are different apparatuses. Alternatively, the printing support apparatus 100 and the printer 210, 210A may be integrated.

In the above-described embodiment, the piece of merchandise and the leaflet are packed in a box. A delivery container is not limited to a box. In one or more embodiments, a piece of merchandise and print products may be packed in a delivery container such as a bag or a case.

The disclosure may take a form of various other embodiments. Various changes such as omission and substitution may be made without departing from the spirit and scope of the disclosure.

These embodiments and modifications thereof are included in the scope and spirit of the disclosure described in the present specification and are included in the invention described in the claims and the scope of equivalents thereof.

### ASPECT OF THE DISCLOSURE

(1) A first aspect of the disclosure provides a non-transitory computer-readable storage medium storing a program that is executable by a computer. The program causes the computer to execute the following: print product information acquisition processing of acquiring print product information on a print product that is to be packed with an item to be shipped; processing of acquiring, based on the print product information, a piece of document data of the print product that is to be packed with the item to be shipped from among pieces of document data of print products, the pieces of document data of print products having been prepared in advance; print job generation processing of generating a print job to print the piece of document data; and processing of providing the print job to a printer and causing the printer to output the print product.
(2) A second aspect of the disclosure provides the non-transitory computer-readable storage medium according to the first aspect, wherein the print job includes an instruction to print print products of varying document sizes.
(3) A third aspect of the disclosure provides the non-transitory computer-readable storage medium according to the first aspect, wherein the print job includes an instruction to eject the print product to one ejection section included in the printer.
(4) A fourth aspect of the disclosure provides the non-transitory computer-readable storage medium according to the third aspect, wherein the printer includes a cutter, and the print job includes an instruction to perform a process of cutting a medium after printing on the medium.
(5) A fifth aspect of the disclosure provides the non-transitory computer-readable storage medium according to the third aspect, wherein the printer includes a cutter, and the print job includes an instruction to perform a process of printing a plurality of the print products on one medium and cutting the medium.
(6) A sixth aspect of the disclosure provides the non-transitory computer-readable storage medium according to the third aspect, wherein the printer includes a cutter, and the print job generation processing includes accepting any one of speed, cost, or a medium as a priority and generating the print job in accordance with the priority.
(7) A seventh aspect of the disclosure provides the non-transitory computer-readable storage medium according to the sixth aspect, wherein the print job generation processing includes the following: in a case where the priority is speed, generating a print job including an instruction to perform a process of printing the print products on a minimum number of one or more media and cutting the one or more media; in a case where the priority is cost, selecting a combination of media that minimizes cost of the media and generating a print job in accordance with the combination; and in a case where the priority is a medium, generating a print job including an instruction to prioritize printing on the medium.
(8) An eighth aspect of the disclosure provides the non-transitory computer-readable storage medium according to the first aspect, wherein the print job generation processing includes generating a print job that includes printing a mailing label that is to be attached to a delivery container in which the item is placed in addition to printing the print product that is to be packed with the item.
(9) A ninth aspect of the disclosure provides the non-transitory computer-readable storage medium according to the eighth aspect, wherein the print job includes the following: an instruction to eject the mailing label to an ejection section that is different from an ejection section to which the print product is ejected; an instruction to eject the mailing label first to the same ejection section as the print product; or an instruction to eject the mailing label last to the same ejection section as the print product.
(10) A tenth aspect of the disclosure provides a printing support apparatus including a hardware processor. The hardware processor is configured to perform the following: acquire print product information on a print product that is to be packed with an item to be shipped; acquire, based on the print product information, a piece of document data of the print product that is to be packed with the item to be shipped from among pieces of document data of print products, the pieces of document data of print products having been prepared in advance; generate a print job of printing the piece of document data; and provide the print job to a printer and cause the printer to output the print product.
(11) An eleventh aspect of the disclosure provides an advertisement printing system including a printing support apparatus and a printer. The printing support apparatus includes a hardware processor. The hardware processor is configured to perform the following: acquire print product information on a print product that is to be packed with an item to be shipped; acquire, based on the print product information, a piece of document data of the print product that is to be packed with the item to be shipped from among pieces of document data of print products, the pieces of document data of print products having been prepared in advance; generate a print job for printing the piece of document data; and provide the print job to a printer and cause the printer to output the print product.
(12) A twelfth aspect of the disclosure provides a printing support method of a printing support apparatus. The printing support method includes the following: acquiring print product information on a print product that is to be packed with an item to be shipped; acquiring, based on the print product information, a piece of document data of the print product that is to be packed with the item to be shipped from among pieces of document data of print products, the pieces of document data of print products having been prepared in advance; generating a print job for printing the piece of document data; and providing the print job to a printer and causing the printer to output the print product.

According to the disclosure, document data that has been prepared in advance by a sales business operator (brand) may be printed as it is and the printed material (print product) may then be packed immediately with a piece of merchandise that is to be shipped. It may therefore be possible to provide a computer program product, a printing support apparatus, an advertisement printing system, and a printing support method that may reduce the man-hours related to an operation of picking a print product that is to be packed with a piece of merchandise in a form suited to an actual condition of a distribution site.

Although embodiments of the disclosure have been described and illustrated in detail, the disclosed embodiments are made for purposes of illustration and example only and not limitation. The scope of the disclosure should be interpreted by terms of the appended claims.

1. A non-transitory computer-readable storage medium storing a program executable by a computer, the program causing the computer to execute:
print product information acquisition processing of acquiring print product information on a print product that is to be packed with an item to be shipped;
processing of acquiring, based on the print product information, a piece of document data of the print product that is to be packed with the item to be shipped from among pieces of document data of print products, the pieces of document data of print products having been prepared in advance;
print job generation processing of generating a print job to print the piece of document data; and
processing of providing the print job to a printer and causing the printer to output the print product.

2. The non-transitory computer-readable storage medium according to claim 1, wherein
the print job includes an instruction to print print products of varying document sizes.

3. The non-transitory computer-readable storage medium according to claim 1, wherein
the print job includes an instruction to eject the print product to one ejection section included in the printer.

4. The non-transitory computer-readable storage medium according to claim 3, wherein
the printer includes a cutter, and
the print job includes an instruction to perform a process of cutting a medium after printing on the medium.

5. The non-transitory computer-readable storage medium according to claim 3, wherein
the printer includes a cutter, and
the print job includes an instruction to perform a process of printing a plurality of the print products on one medium and cutting the medium.

6. The non-transitory computer-readable storage medium according to claim 3, wherein
the printer includes a cutter, and
the print job generation processing includes:
accepting any one of speed, cost, or a medium as a priority; and
generating the print job in accordance with the priority.

7. The non-transitory computer-readable storage medium according to claim 6, wherein
the print job generation processing includes:
in a case where the priority is speed, generating a print job including an instruction to perform a process of printing the print products on a minimum number of one or more media and cutting the one or more media;
in a case where the priority is cost, selecting a combination of media that minimizes cost of the media and generating a print job in accordance with the combination; and
in a case where the priority is a medium, generating a print job including an instruction to prioritize printing on the medium.

8. The non-transitory computer-readable storage medium according to claim 1, wherein
the print job generation processing includes generating a print job that includes printing a mailing label that is to be attached to a delivery container in which the item is placed in addition to printing the print product that is to be packed with the item.

9. The non-transitory computer-readable storage medium according to claim 8, wherein
the print job includes:
an instruction to eject the mailing label to an ejection section that is different from an ejection section to which the print product is ejected;
an instruction to eject the mailing label first to the same ejection section as the print product; or
an instruction to eject the mailing label last to the same ejection section as the print product.

10. A printing support apparatus comprising a hardware processor, wherein
the hardware processor is configured to:
acquire print product information on a print product that is to be packed with an item to be shipped;
acquire, based on the print product information, a piece of document data of the print product that is to be packed with the item to be shipped from among pieces of document data of print products, the pieces of document data of print products having been prepared in advance;
generate a print job of printing the piece of document data; and
provide the print job to a printer and cause the printer to output the print product.

11. An advertisement printing system comprising:
a printing support apparatus; and
a printer, wherein
the printing support apparatus comprises a hardware processor, and
the hardware processor is configured to:
acquire print product information on a print product that is to be packed with an item to be shipped;
acquire, based on the print product information, a piece of document data of the print product that is to be packed with the item to be shipped from among pieces of document data of print products, the pieces of document data of print products having been prepared in advance;
generate a print job for printing the piece of document data; and
provide the print job to a printer and cause the printer to output the print product.

12. A printing support method of a printing support apparatus, wherein
the printing support method comprises:
acquiring print product information on a print product that is to be packed with an item to be shipped;
acquiring, based on the print product information, a piece of document data of the print product that is to be packed with the item to be shipped from among pieces of document data of print products, the pieces of document data of print products having been prepared in advance;
generating a print job for printing the piece of document data; and
providing the print job to a printer and causing the printer to output the print product.
